(19) United States
(12) Patent Application Publication
(10) Pub. No.: US 2024/0288717 A1
(43) Pub. Date: Aug. 29, 2024

(54) THERMO-OPTIC PHASE SHIFTER SYSTEMS AND METHODS

(71) Applicant: CISCO TECHNOLOGY, INC., San Jose, CA (US)

(72) Inventors: Xue Huang, Maynard, MA (US); Leonard Ketelsen, Maynard, MA (US)

(73) Assignee: CISCO TECHNOLOGY, INC., San Jose, CA (US)

(21) Appl. No.: 18/114,761

(22) Filed: Feb. 27, 2023

(51) Int. Cl. G02F 1/01; G02F 1/21; G02F 1/225

(52) U.S. Cl. CPC G02F 1/0147; G02F 1/212; G02F 1/225

(57) ABSTRACT

In part, the disclosure relates to opto-electrical system. The system may include a waveguide defining an optical input and an optical output; a thermo-optic phase shifter (TOPS) that includes a first electrical contact and a second electrical contact, and a resistive heater in electrical communication with the first electrical contact and the second electrical contact, the TOPS configured to change a first phase of light entering the optical input to a second phase for light exiting the optical output, the TOPS having a resistance R_{TOPS}, the TOPS in thermal communication with the waveguide; a voltage source in electrical communication with the first electrical contact; and a resistor that includes a first end and a second end, the resistor having a resistance R_{S}, wherein the first end is grounded, wherein the second end is in electrical communication with the second electrical contact.

### FIELD

This disclosure relates generally to the field of photonic integrated circuits.

### BACKGROUND

Contemporary photonic systems make extensive use of photonic integrated circuits that are advantageously mass-produced in various configurations for various purposes.

### SUMMARY

In part, in one aspect, the disclosure relates to a thermos optic phase shifter (TOPS) system and methods that stabilize the electrical bias applied to the TOPS. In one aspect, the disclosure relates to a TOPS in a voltage divider circuit configuration with a series resistance chosen to match the electrical resistance of the TOPS.

In part, the disclosure relates to opto-electrical system. The system may include a waveguide defining an optical input and an optical output; a thermo-optic phase shifter (TOPS) that includes a first electrical contact and a second electrical contact, and a resistive heater in electrical communication with the first electrical contact and the second electrical contact, the TOPS configured to change a first phase of light entering the optical input to a second phase for light exiting the optical output, the TOPS having a resistance R_{TOPS}, the TOPS in thermal communication with the waveguide; a voltage source in electrical communication with the first electrical contact; and a resistor that includes a first end and a second end, the resistor having a resistance RS, wherein the first end is grounded, wherein the second end is in electrical communication with the second electrical contact.

In some embodiments, Rₛ is substantially equal to R_{TOPS}. In some embodiments, K=|Rₛ−R_{TOPS}|/R_{TOPS}, wherein K is less than or equal to about 0.2. In various embodiments, the resistor is a variable resistor and Rₛ is a variable resistance. In various embodiments, Rₛ is selected such that Rₛ is approximately the same as R_{TOPS}. In many embodiments, Rₛ is selected such that K is less than or equal to about 0.2, wherein K=|Rₛ−R_{TOPS}|/R_{TOPS}. In various embodiments, Rₛ is selected to stabilize power bias applied to TOPS from voltage source during aging of TOPS or temperature changes of the TOPS. In some embodiments, Rₛ ranges from about 1 ohm to about 1,000 ohms.

In some embodiments, the resistive heater is in electrical communication with the voltage source and the resistor, wherein the resistive heater is configured to generate heat when electrical power is applied thereto, wherein a heating temperature of the resistive heater increases with application of increasing electrical power. In some embodiments, the system may include a photonic integrated circuit (PIC), wherein the TOPS is usually part of the PIC, and is in thermal communication with the PIC, wherein the PIC includes a device or is in communication with the device, wherein the device is selected from the group consisting of a laser, a transceiver, a variable optical attenuator, a tunable optical filter; a ring resonator; a phase tuner, a Mach-Zehnder interferometers (MZI), and a modulator.

In another aspect, in part, the disclosure relates to a method of operating an electro-optical device with improved reliability thereof. The method may include providing a thermo-optic phase shifter (TOPS), the TOPS includes a first electrical contact and a second electrical contact; simulating an impedance between the first electrical contact and the second electrical contact of the TOPS as a resistance R_{TOPS}; electrically coupling the first electrical contact to a voltage source; and selecting a resistor that includes a first end and a second end and having a resistance Rₛ such that when the first end is grounded and the second end is electrically coupled to the second electrical contact a power bias of the TOPS remains substantially stable during temperature changes of the TOPS.

In some embodiments, substantially stable means or corresponds to electrical power applied to the TOPS from the voltage source being insensitive to TOPS resistance changes. In some embodiments, Rₛ is substantially equal to R_{TOPS}. In many embodiments, K=|Rₛ−R_{TOPS}|/R_{TOPS}, wherein K is less than or equal to about 0.2. In various embodiments, the resistor is a variable resistor and Rₛ is a variable resistance, that includes the step of adjusting Rₛ until |Rₛ−R_{TOPS}|/R_{TOPS} is less than or equal to about 0.2. In some embodiments, the TOPS remaining substantially stable avoids measuring voltage source corresponding to identify changes in R_{TOPS} over time due to aging or temperature changes of the TOPS.

In some embodiments, the electrical power of the TOPS may be determined using the following relationship P(φ)=(V_{source}(φ)/R_{TOPS}+Rₛ)²·R_{TOPS}, wherein φ is a phase angle and wherein dP(φ)/dR_{TOPS}=V_{source}² (φ)·Rₛ²−R_{TOPS}²/R_{TOPS}+Rₛ)⁴. In various embodiments, the method may further include selecting Rₛ to be approximately equal to R_{TOPS} is determined by finding a zero value of dP(φ)/dR_{TOPS}. In various embodiments, the method may further include integrating the TOPS into a photonic integrated circuit. In many embodiments, when the TOPS resistance changes by 10%, under the same voltage source bias, the electrical power applied to the TOPS changes by an amount less than or equal to about 0.3% or less than or equal to about 0.2%.

In yet another aspect, in part, the disclosure relates to an opto-electrical system. The system may include a waveguide defining an optical input and an optical output; a thermo-optic phase shifter (TOPS) that includes a first electrical contact and a second electrical contact, the TOPS configured to change a first phase of light entering the optical input to a second phase of light, wherein light exiting the optical output is of the second phase, the TOPS having a resistance R_{TOPS}, the TOPS in thermal communication with the waveguide, a resistor that includes a first end and a second end, the resistor having a resistance R_{S}, wherein the first end is in electrical communication with the first electrical contact, wherein the second electrical contact is grounded; and a voltage source in electrical communication with the second end.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation. Further, the various apparatus, optical elements, passivation coatings/layers, optical paths, waveguides, splitters, couplers, combiners, electro-optical devices, thermo-optic phase shifters, voltage sources, resistors, heaters, photonic integrated circuits (PICs), inputs, outputs, ports, channels, components and parts of the foregoing disclosed herein can be used with any laser, laser-based communication system, waveguide, fiber, transmitter, transceiver, receiver, and other devices and systems without limitation.

These and other features of the applicant's teachings are set forth herein.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings in which:

FIG. 1 is a circuit diagram of a thermo-optic phase shifter (TOPS) with marked nodes at the electrical contacts of the TOPS according to an exemplary embodiment of the disclosure.

FIG. 2 is a circuit diagram of a TOPS and a series resistance designed to measure a change in a TOPS resistance via an analog-to-digital converter (ADC) according to an exemplary embodiment of the disclosure.

FIG. 3A is a circuit diagram of a voltage divider wherein the bottom resistor is selected to have resistance that matches the electrical resistance of the TOPS within various permitted variations according to an exemplary embodiment of the disclosure.

FIG. 3B is a circuit diagram of a TOPS in a voltage divider wherein the bottom resistor is a variable resistor according to an exemplary embodiment of the disclosure.

FIG. 3C is a circuit diagram of a TOPS in a voltage divider wherein the TOPS and the resistor are in an alternative configuration according to an exemplary embodiment of the disclosure.

FIG. 4 is a plot of a percent change in power applied to a TOPS versus a percent change in an electrical resistance of a TOPS according to an exemplary embodiment of the disclosure.

FIG. 5 is a flow chart of an exemplary method suitable for improving stability of a TOPS according to an exemplary embodiment of the disclosure.

### DETAILED DESCRIPTION

In many embodiments, a thermo-optic phase shifter (TOPS) may be used with or integrated with a waveguide that has an optical input and an optical output. In most embodiments, the TOPS is in thermal communication with a waveguide and/or other electro-optical devices. In most embodiments, the TOPS has two electrical connections such a first electrical contact and a second electrical contact. An applied electrical bias, e.g. from an external voltage source, across the electrical contacts may change a phase of light entering at the optical input to a new optical phase of light exiting from the optical output. As such, in many embodiments, a TOPS may be used in conjunction with or to tune other optical devices such as Mach-Zehnder interferometers (MZI), ring resonators, external-cavity lasers, tunable optical filters, variable optical attenuators, optical modulators, phase tuners, optical transceivers etc.

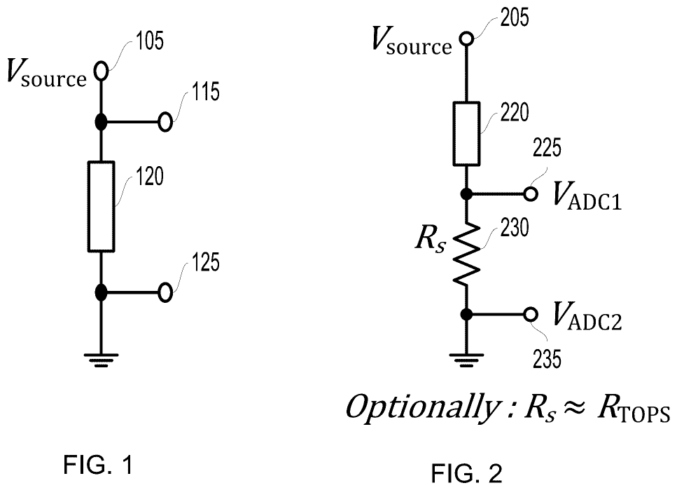

Refer now to the exemplary embodiment of FIG. 1. FIG. 1 is a diagram of a TOPS element 120, with a first electrical contact 115 and a second electrical contact 125, driven by a source 105 according to an exemplary embodiment of the disclosure. In various embodiments, the source 105 is a voltage source. In many embodiments, an electrical bias applied to a TOPS may determine the optical phase or transmission wavelength of the optical waveguides which are in thermal connection with the TOPS. In many embodiments, a relationship between an optical phase or transmission wavelength and an applied power to a TOPS may be calibrated. In some embodiments, a calibration may be performed by measuring an optical phase φ at the optical output and by calculating an electrical power P(φ) corresponding to an applied voltage V_{source}:

$$P ( φ ) = \frac{{V}_{source}^{2} ( φ )}{{R}_{TOPS 0}} \qquad ( 1 )$$

where R_{TOPS0} is an electrical resistance of the TOPS, i.e. between the first electrical contact and the second electrical contact of the TOPS, measured at its beginning of life (BOL).

Conversely, in many embodiments, by using a calibrated relationship P(φ), a source voltage V_{source} suitable to achieve a particular optical phase φ may be calculated as

$${V}_{source} = \sqrt{P ( φ ) \cdot {R}_{TOPS}} , \qquad ( 2 )$$

where R_{TOPS} is a current value of the TOPS resistance. However, in most embodiments, because the resistance of the TOPS may change substantially (up to 10% or more) over the lifetime of the TOPS and/or in response to temperature fluctuations, the value R_{TOPS} taken at the time of the calculation above may differ from the resistance value R_{TOPS0} used at the TOPS BOL during calibration due to changes in temperature or normal aging of the TOPS. Furthermore, in many embodiments, the electrical resistance R_{TOPS} of the TOPS needs be monitored to periodically calculate the applicable source voltage, V_{source} to accounts for TOPS resistance changes or other phenomena.

Refer now to the example embodiment of FIG. 2. FIG. 2 is a circuit diagram of a TOPS 220, driven by a source 205, and a series resistor 230 having a resistance Rₛ according to an exemplary embodiment of the disclosure. In some embodiments, an analog to digital converter (ADC) may be used to monitor the voltage drop across the series resistor 230, i.e. the difference in voltages V_{ADC1} and V_{ADC2}, as a way to monitor the TOPS resistance R_{TOPS}. The voltage drop may be measured at the two nodes or electrical contacts 225 and 235 that correspond to V_{ADC1} and V_{ADC2}, respectively. The current through the series resistance is V_{ADC1}−V_{ADC2}/Rₛ and so the real-time resistance of the TOPS is

$${R}_{TOPS} = \frac{{V}_{source} - {V}_{ADC 1}}{{V}_{ADC 1} - {V}_{ADC 2}} \cdot {R}_{s} \qquad ( 3 )$$

Thus, considering the real-time value of the TOPS resistance R_{TOPS}, a source voltage suitable to achieve an output optical phase of φ may be specified using the following:

$${V}_{source} ( φ ) = \sqrt{\frac{P ( φ )}{{R}_{TOPS}}} \cdot ( {R}_{s} + {R}_{TOPS} ) \qquad ( 4 )$$

However, in many embodiments, the use of an ADC to monitor the series resistance adds computational, power, ADC, and area costs to the integrated circuit. As discussed in more detail below, in many embodiments, Rₛ is optionally selected or adjusted such that Rₛ≈R_{TOPS}. The selection of Rₛ≈R_{TOPS} allows the continuous monitoring of resistor 230 to be avoided and advantageously saves on hardware and power costs as discussed in more detail below.

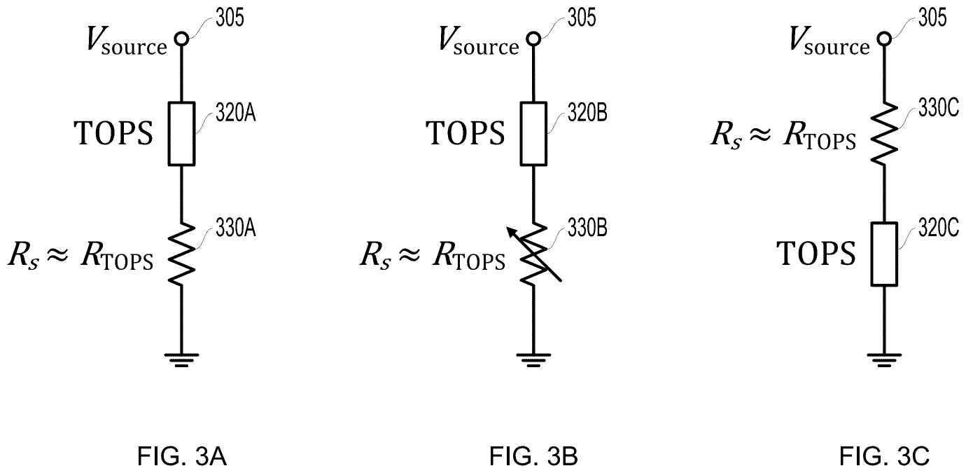

Refer now to the exemplary embodiment of FIG. 3A. FIG. 3A is a diagram of a circuit configuration as disclosed herein that mitigates the effect of the change in electrical resistance R_{TOPS} of the TOPS 320A on the variability of the calibration and obviates the need for real-time ADC monitoring according to an exemplary embodiment of the disclosure. In some embodiments, the impedance of a given TOPS may be simulated as a resistor having a resistance R_{TOPS} (or one or more resistors in some embodiments). The source 305 is a voltage source. In many embodiments, a resistance Rₛ 330A having a value substantially equal to the resistance of the TOPS R_{TOPS} (taken at some moment in time, e.g. at BOL) may be added in series with the TOPS or otherwise electrically coupled thereto to form a voltage divider configuration. In most embodiments, when Rₛ≈R_{TOPS}, or equivalently when a ratio K=|Rₛ−R_{TOPS}/R_{TOPS} is close to zero, the bias on the TOPS remains stable. In most embodiments, the power applied to the TOPS is equal to

$$P ( φ ) = {( \frac{{V}_{source} ( φ )}{{R}_{TOPS} + {R}_{s}} )}^{2} \cdot {R}_{TOPS} \qquad ( 5 )$$

The rate at which the power P(φ) changes with R_{TOPS} is

$$\frac{dP ( φ )}{{dR}_{TOPS}} = {V}_{source}^{2} ( φ ) \cdot \frac{{R}_{s}^{2} - {R}_{TOPS}^{2}}{{( {R}_{TOPS} + {R}_{s} )}^{4}} \qquad ( 6 )$$

which is close to, approximately equal, or even equals zero when Rₛ≈R_{TOPS}. In some embodiments, Rs may be used to designate the resistance of the resistor used in a given circuit such as the voltage divider configurations shown herein, and also used to identify or label the resistor itself. In some embodiments, K is greater than about 0 and less than about 0.3. In some embodiments, K is greater than about 0 and less than about 0.2. In some embodiments, K is greater than about 0 and less than about 0.1. In some embodiments, K is greater than about 0 and less than about 0.05.

Refer also to the embodiment of FIG. 3B. FIG. 3B is an alternative circuit configuration using a variable resistor 330B in series with the TOPS 320B according to an exemplary embodiment of the disclosure. A variable resistor may allow more precise matching of the series resistance Rₛ and the TOPS resistance R_{TOPS} at various stages of the device's fabrication or operation. For example, in some embodiments, given the advantages of having Rₛ≈R_{TOPS}, the variable resistor having resistance Rₛ may be set at R_{TOPS} or about R_{TOPS} or approximately R_{TOPS} In various embodiments, Rₛ may be selected (if fixed) or set (if variable) such that |Rₛ−R_{TOPS}|/R_{TOPS} is less than about 0.2. As shown in the embodiments, of FIGS. 3A and 3B, the resistor may be grounded.

Refer also to the embodiment of FIG. 3C. FIG. 3C is an alternative circuit configuration wherein the TOPS and the resistor Rₛ are reversed in position relative to the embodiments of FIG. 3A or 3B. As shown, the TOPS 320C is the bottom element in the voltage divider and the resistor Rₛ 330C is the top element in the voltage divider. In some embodiments, one terminal or electrical contact of the TOPS 320C may be grounded as shown. In the embodiment of FIG. 3C, the resistor Rₛ is chosen in a manner similar to that of the embodiment of FIG. 3A, i.e. Rₛ≈R_{TOPS} or equivalently |Rₛ−R_{TOPS}|/R_{TOPS}≈0. The relationships P(φ) and |dP(φ)/R_{TOPS}| (Equations (5) and (6), respectively) are symmetric with respect to Rₛ and R_{TOPS} and so the bias to the TOPS in the embodiment of FIG. 3C remains substantially stable. In general, in various embodiments, the various components disclosed herein may be electrically coupled or connected in various configurations that incorporate the voltage divider features and the advantages relative to TOPS bias stability and reliability over time. In various embodiments, the TOPS may include one or more heating elements or devices such as, for example, a resistive heater.

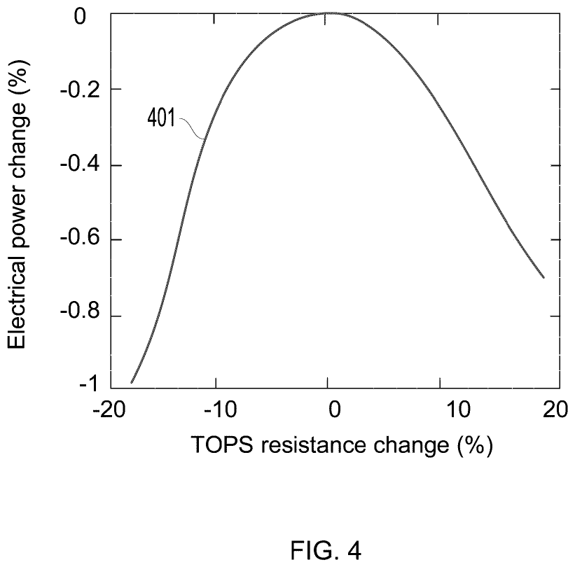

Refer now to FIG. 4. FIG. 4 is a plot 401 of a percent change in electrical power P (applied to the TOPS) versus a percent change in TOPS resistance R_{TOPS} using a voltage divider configuration as disclosed herein, such as in FIG. 3A, 3B, or 3C, wherein Rₛ≈R_{TOPS}. According to FIG. 4, a 10% change R_{TOPS} produces a change of less than about 0.3% or less than about 0.2% in the power applied to the TOPS, under the same voltage source bias (at 305 as shown in FIGS. 3A, 3B, and 3C) as calibration value. In short, the TOPS circuit configuration enables stable electrical power bias on TOPS (change by less than about 0.3%), even if the TOPS resistance has changed dramatically.

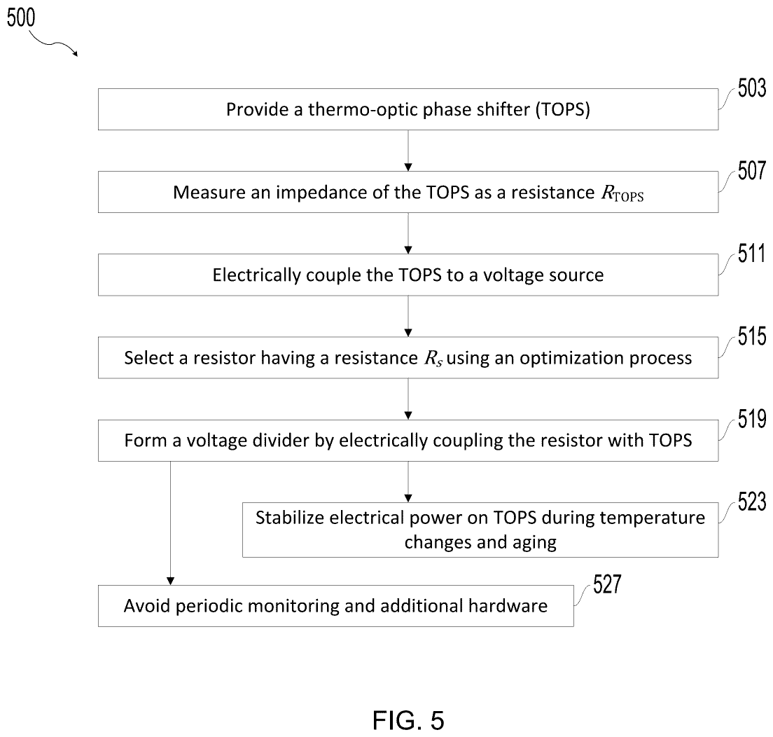

Refer now to FIG. 5. FIG. 5 is a flow chart of a method 500 for improving the stability of an electrical bias of a TOPS. In many embodiments, a provided TOPS 503 is first measured 507 to obtain a resistance R_{TOPS}, where R_{TOPS}=R_{TOPS0} if the measurement is taken at the TOPS BOL. In most embodiments, the TOPS is then electrically coupled 511 to a voltage source. In most embodiments, a resistor is then selected 515 having resistance Rₛ chosen according to an optimization process wherein Rₛ≈R_{TOPS}. In some embodiments, the resistor is fixed or variable. In some embodiments, the optimization process may including find a relative maxima or minima of the relationship of dP(φ)/dR_{TOPS} as described above with regard to equation 6. In some embodiments, other optimization methods such as interpolation, curve fitting, and the tuning of a variable resistor may be used. The TOPS and the resistor are then electrically coupled in series to define or create a voltage divider configuration. In many embodiments, the resultant circuit configuration stabilizes 523 the electrical power on TOPS and the optical phase tuning of the TOPS during temperature changes and device aging. In most embodiments, such a voltage divider configuration furthermore avoids 527 continuous or periodic monitoring of the voltage drop across the TOPS and so also avoids additional area- and cost-consuming ADC channels dedicated to the TOPS.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

The use of headings and sections in the application is not meant to limit the disclosure; each section can apply to any aspect, embodiment, or feature of the disclosure. Only those claims which use the words “means for” are intended to be interpreted under 35 USC 112. Absent a recital of “means for” in the claims, such claims should not be construed under 35 USC 112. Limitations from the specification are not intended to be read into any claims, unless such limitations are expressly included in the claims.

Embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a computer program product embodied in one or more computer readable medium(s) having computer readable program code embodied thereon.

What is claimed is:

1. An opto-electrical system comprising:
a waveguide defining an optical input and an optical output;
a thermo-optic phase shifter (TOPS) comprising
a first electrical contact and a second electrical contact, and
a resistive heater in electrical communication with the first electrical contact and the second electrical contact,
the TOPS configured to change a first phase of light entering the optical input to a second phase for light exiting the optical output,
the TOPS having a resistance R_{TOPS},
the TOPS in thermal communication with the waveguide;
a voltage source in electrical communication with the first electrical contact; and
a resistor comprising a first end and a second end, the resistor having a resistance R_{S}, wherein the first end is grounded, wherein the second end is in electrical communication with the second electrical contact.

2. The system of claim 1, wherein Rₛ is substantially equal to R_{TOPS}.

3. The system of claim 1, wherein K=|Rₛ−R_{TOPS}|/R_{TOPS}, wherein K is less than or equal to about 0.2.

4. The system of claim 1, wherein the resistor is a variable resistor and Rₛ is a variable resistance.

5. The system of claim 4, wherein Rₛ is selected such that Rₛ is approximately the same as R_{TOPS}.

6. The system of claim 4, wherein Rₛ is selected such that K is less than or equal to about 0.2, wherein K=|Rₛ−R_{TOPS}|/R_{TOPS}.

7. The system of claim 1, wherein Rₛ is selected to stabilize power bias applied to TOPS from voltage source during aging of TOPS or temperature changes of the TOPS.

8. The system of claim 1, wherein Rₛ ranges from about 1 ohm to about 1,000 ohms.

9. The system of claim 1, wherein the resistive heater is in electrical communication with the voltage source and the resistor, wherein the resistive heater is configured to generate heat when electrical power is applied thereto, wherein a heating temperature of the resistive heater increases with application of increasing electrical power.

10. The system of claim 1 further comprising a photonic integrated circuit (PIC), wherein the TOPS is usually part of the PIC, and is in thermal communication with the PIC, wherein the PIC comprises a device or is in communication with the device, wherein the device is selected from the group consisting of a laser, a transceiver, a variable optical attenuator, a tunable optical filter; a ring resonator; a phase tuner, a Mach-Zehnder interferometers (MZI), and a modulator.

11. A method of operating an electro-optical device with improved reliability thereof, the method comprising:
providing a thermo-optic phase shifter (TOPS), the TOPS comprising a first electrical contact and a second electrical contact;
simulating an impedance between the first electrical contact and the second electrical contact of the TOPS as a resistance R_{TOPS};
electrically coupling the first electrical contact to a voltage source; and
selecting a resistor comprising a first end and a second end and having a resistance Rₛ such that when the first end is grounded and the second end is electrically coupled to the second electrical contact a power bias of the TOPS remains substantially stable during temperature changes of the TOPS.

12. The method of claim 11, wherein substantially stable means or corresponds to electrical power applied to the TOPS from the voltage source being insensitive to TOPS resistance changes.

13. The method of claim 11, wherein Rₛ is substantially equal to R_{TOPS}.

14. The method of claim 11, wherein K=|Rₛ−R_{TOPS}|/R_{TOPS}, wherein K is less than or equal to about 0.2.

15. The method of claim 11, wherein the resistor is a variable resistor and Rₛ is a variable resistance, further comprising the step of adjusting Rₛ until |Rₛ−R_{TOPS}|/R_{TOPS} is less than or equal to about 0.2.

16. The method of claim 11 wherein the TOPS remaining substantially stable avoids measuring voltage source corresponding to identify changes in R_{TOPS} over time due to aging or temperature changes of the TOPS.

17. The method of claim 11, wherein the electrical power of the TOPS may be determined using the following relationship P(φ)=(V_{source}(φ)/R_{TOPS}+Rₛ)²·R_{TOPS}, wherein φ is a phase angle and wherein dP(φ)/dR_{TOPS}=V_{source}²(φ)·Rₛ²−R_{TOPS}²/(R_{TOPS}+Rₛ)⁴.

18. The method of claim 17 further comprising selecting Rₛ to be approximately equal to R_{TOPS} is determined by finding a zero value of dP(φ)/dR_{TOPS}.

19. The method of claim 11 further comprising integrating the TOPS into a photonic integrated circuit.

20. The method of claim 12, wherein when the TOPS resistance changes by 10%, under the same voltage source bias, the electrical power applied to the TOPS changes by an amount less than or equal to about 0.3% or less than or equal to about 0.2%.

21. An opto-electrical system comprising:
a waveguide defining an optical input and an optical output;
a thermo-optic phase shifter (TOPS) comprising
a first electrical contact and a second electrical contact,
the TOPS configured to change a first phase of light entering the optical input to a second phase of light, wherein light exiting the optical output is of the second phase,
the TOPS having a resistance R_{TOPS},
the TOPS in thermal communication with the waveguide,
a resistor comprising a first end and a second end, the resistor having a resistance R_{S}, wherein the first end is in electrical communication with the first electrical contact, wherein the second electrical contact is grounded; and
a voltage source in electrical communication with the second end.
